(19) United States
(12) Patent Application Publication
(10) Pub. No.: US 2019/0381627 A1
(43) Pub. Date: Dec. 19, 2019

(54) GRINDING ASSEMBLIES FOR GRINDING WELDING RODS

(71) Applicant: Seyedhadi Hosseini, Baytown, TX (US)

(72) Inventor: Seyedhadi Hosseini, Baytown, TX (US)

(21) Appl. No.: 16/438,719

(22) Filed: Jun. 12, 2019

Related U.S. Application Data
(60) Provisional application No. 62/684,841, filed on Jun. 14, 2018.

(51) Int. Cl. B24B 19/16; B23K 35/40

(52) U.S. Cl. CPC B24B 19/16; B23K 35/40

(57) ABSTRACT

One or more specific versions disclosed herein include a grinding assembly for grinding a welding rod, which grinding assembly may include: a pedestal; a motor having a drive shaft extending through the pedestal; a chuck coupled to the drive shaft; a housing coupled to the pedestal; an abrasive disc coupled to the chuck and disposed within the housing; and a ball joint coupled to the housing and capable of spherical rotation, the ball joint comprising an aperture capable of receiving a portion of the welding rod.

### CROSS REFERENCE TO RELATED APPLICATIONS

This application claims benefit to U.S. Provisional Application No. 62/684,841, filed on Jun. 14, 2018; and this application hereby incorporates herein U.S. Provisional Application No. 62/684,841 as if set forth herein in its entirety.

### BACKGROUND

### 1. Field of Inventions

The field of this application and any resulting patent is grinding assemblies for grinding welding rods, preferably for tungsten welding rods.

### 2. Description of Related Art

Various grinding assemblies and methods for grinding welding rods, have been proposed and utilized, including some of the methods and structures disclosed in some of the references appearing on the face of this application or issued patent. However, those methods and structures lack the combination of steps and/or features of the methods and/or structures covered by what is disclosed herein. Furthermore, it is contemplated that the methods and/or structures disclosed herein solve many of the problems that prior art methods and structures have failed to solve. Also, the methods and/or structures disclosed herein have benefits that would be surprising and unexpected to a hypothetical person of ordinary skill with knowledge of the prior art existing as of the filing date of this application.

### SUMMARY

The disclosure herein includes a grinding assembly for grinding a welding rod, which grinding assembly may include: a pedestal; a motor having a drive shaft extending through the pedestal; a chuck coupled to the drive shaft; a housing coupled to the pedestal; an abrasive disc coupled to the chuck and disposed within the housing; and a ball joint coupled to the housing and capable of spherical rotation, the ball joint comprising an aperture capable of receiving a portion of the welding rod.

The disclosure herein includes a grinding assembly for grinding a welding rod, which grinding assembly may include: a motor having a shell and a drive shaft; a chuck; a pedestal coupled to the shell, the pedestal having an aperture through which the chuck is extended; an abrasive assembly removably coupled to the chuck; a housing slidably coupled to the pedestal, the housing comprising: socket disposed therethrough; and a box thread extended through the housing and connected to the socket; a ball joint rotatably coupled to the socket of the housing, the ball joint comprising an aperture disposed therethrough; and a knob threadably extended through the box thread and releasably abutted against the ball joint.

The disclosure herein includes a grinding assembly for grinding a welding rod, which grinding assembly may include: a motor having a shell and a drive shaft; a chuck; a pedestal coupled to the shell, wherein the pedestal comprises: an aperture through which the chuck is extended; an abrasive assembly rotatably coupled to the chuck; a housing slidably coupled to the pedestal, the housing comprising: a base; a wall; a box thread extended through the base; and socket disposed in the wall; and a slot extended through the base and the wall; a ball joint disposed in the socket of the housing; and a knob threadably extended through the box thread of the housing and releasably abutted against the ball joint.

The disclosure herein includes a grinding assembly for grinding a welding rod, which grinding assembly may include: a motor having a shell and a drive shaft; a chuck; a pedestal coupled to the shell, the pedestal comprising: a central aperture through which the chuck extends; and a groove disposed in an outer surface of the pedestal; an abrasive assembly removably coupled to the chuck, a housing slidable coupled to the pedestal, the housing comprising: a base; a wall; a box thread extended through the base a socket disposed in the wall; a first box thread disposed through the base; a second box thread disposed through the wall and aligned with the groove of the pedestal; a slot extending through the base and the wall, wherein the slot is capable of receiving a portion of the welding rod; and a threaded assembly capable of being extended through the wall and into the second groove of the pedestal; a ball joint comprising: a ball disposed in the socket of the housing; a stem extending from to the ball; and an aperture extended through the ball and the stem and is capable of receiving a portion of the welding rod; a ball joint retainer coupled to the wall of the housing and abutted against the ball of the ball joint; a knob threadably extended through the first box thread disposed through the base of the housing; and a threaded assembly threadably extended through the second box thread and the groove of the of the pedestal.

The disclosure herein includes a grinding assembly for grinding a welding rod, which method may include: a pedestal; a motor having a drive shaft extending through the pedestal; a chuck coupled to the drive shaft, the chuck comprising: a first cylinder having a face; and a second cylinder extending from the first cylinder; a housing coupled to the pedestal; and a grinding disc disposed in the housing, the abrasive disc comprising: an upper planar surface; a lower planar surface abutted against the face of the first cylinder; and an aperture receiving a portion of the second cylinder.

The disclosure herein includes a method of grinding a welding rod, which method may include: providing a grinding assembly, comprising: a pedestal; a motor coupled to the pedestal; a chuck rotatably coupled to the motor; a housing coupled to the pedestal; an abrasive disc coupled to the chuck and disposed in the housing; and a ball joint coupled to the housing and capable of spherical rotation; inserting an end of the welding rod through an aperture of the ball joint; spherically rotating the ball joint; abutting the end of the welding rod against the abrasive disc; rotating the abrasive disc with the motor; and grinding the end of the welding rod with the abrasive disc.

### BRIEF DESCRIPTION OF THE DRAWINGS

FIG. 1 illustrates an exploded view of a grinding assembly.

FIG. 2 illustrates a cross-sectional side view of a pedestal coupled to a housing.

FIG. 3A illustrates exploded view of side view of an abrasive assembly.

FIG. 3B illustrates a perspective view of an abrasive assembly.

FIG. 4 illustrates an exploded view of a pedestal and a housing.

FIGS. 5A-B illustrate cross-sectional side views of grinding assemblies.

FIG. 6 illustrates a top plan view of a grinding assembly.

### DETAILED DESCRIPTION

### 1. Introduction

A detailed description will now be provided. The purpose of this detailed description, which includes the drawings, is to satisfy the statutory requirements of 35 U.S.C. § 402. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

### 2. Selected Definitions

Certain claims include one or more of the following terms which, as used herein, are expressly defined below.

The term “abrasive” as used herein is defined as capable of grinding and/or sharpening.

The term “abrasive disc” as used herein is defined as a structure having an abrasive surface, e.g., for abutment against a welding rod. An abrasive disc may be referred to as a “grinding disc.” An abrasive disc may have an upper planar surface and a lower planar surface. An abrasive disc may have an aperture extended therethrough. An abrasive disc may have an aperture extending through an upper planar surface and a lower planar surface of the abrasive disc. An abrasive disc may be substantially flat, e.g. planar. An abrasive disc may be substantially circular. An abrasive disc may include abrasive material, e.g., minerals, sand, or diamond particles, disposed on a surface of a body, e.g. disc or cylinder. An abrasive disc may be adjacent a pedestal but, in some cases, may not be in physical contact with pedestal. An abrasive disc may be rotated, e.g., spun, relative to a pedestal. An abrasive disc may be rotated, e.g., spun, by a motor. An abrasive disc may be part of an abrasive assembly. An abrasive assembly may include a stem coupled to an abrasive disc. An abrasive assembly may include a stem and an abrasive disc that share a central axis. An abrasive assembly may have a stem having an end coupled to a chuck of a motor.

The term “abutted against” as used herein is defined as being positioned adjacent to and either physically touching or pressing against, directly or indirectly. A first object may be abutted against a second object such that the second object is limited from moving in a direction of the first object. For example, a ball joint retainer may have a portion abutted against a ball of a ball joint. Alternatively, a first object may be abutted against a second object such that movement of the first object relative to the second object causes friction between the first object and the second object. For example, a welding rod may be abutted against an abrasive assembly.

The term “adjacent” as used herein is defined as next to and may include physical contact but does not require physical contact. For example, a ball joint may have ball that is adjacent to a stem. Additionally, a housing may be disposed adjacent to a pedestal. Additionally, a ball joint retainer may be disposed adjacent a wall of a housing.

The term “aperture” as used herein is defined as any opening in a solid object or structure. For example, an aperture may be an opening that begins on one side of the solid object and ends on the other side of the object, e.g., as a slot. An aperture may be an opening that does not pass entirely through the object, but only partially passes through, e.g., as a groove, a notch, or a score. An aperture can be an opening in an object that is completely circumscribed, defined, or delimited by the object itself. Alternatively, an aperture can be an opening in the object when the object is combined with one or more other objects or structures. One or more apertures may be disposed and passed entirely through a pedestal or a wall or a base of a housing. An aperture may receive another object, e.g. a threaded assembly, a knob, a chuck, a drive shaft, or ball joint. An aperture may provide for ingress and/or egress of an object, e.g., a welding rod, a bolt, a screw, a knob, or a stem and/or ball of a ball joint, through the aperture.

The term “ball joint” as used herein is defined as structure having a ball configured for coupling to a socket. A ball joint is capable of being spherically rotated, pivoted, and/or swiveled in a socket. A ball joint may include a ball and a stem. Preferably, a ball and a stem of a ball joint are unitary. A ball joint may have an aperture that is extended through a ball and a stem of the ball joint. In some cases, a ball joint and a stem may be separate structures. A ball joint may be threadably coupled to a stem. A ball joint and a stem may share a central axis. A ball joint may have a first surface, defining a first aperture, having a first inner diameter larger than or equal to a second inner diameter of a second surface of a stem, defining a second aperture.

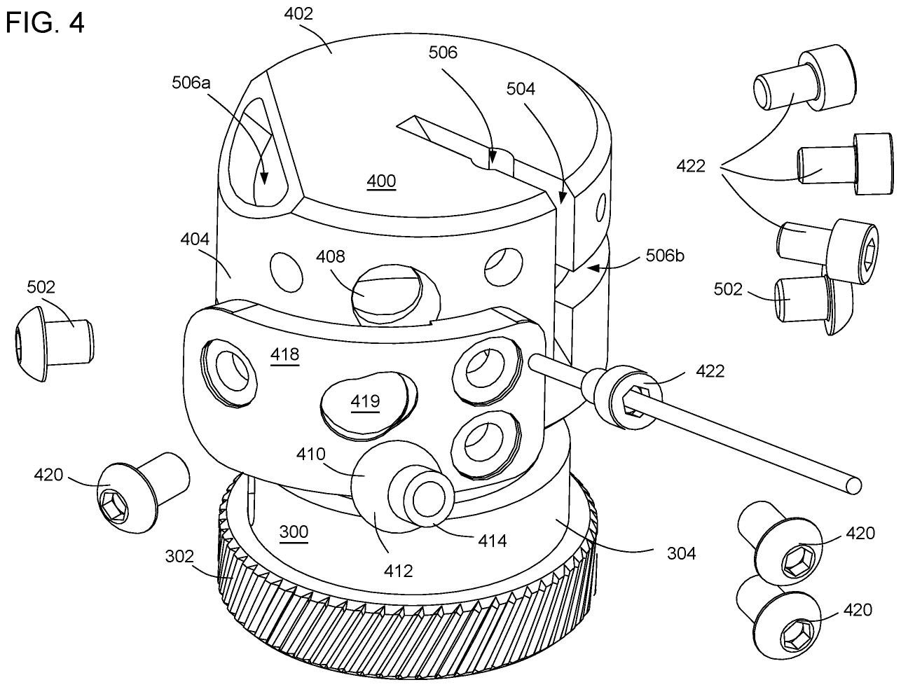

The term “ball joint retainer” as used herein refers to a structure having an inner surface and an outer surface that are preferably parallel to one another, which structure is capable of directly or indirectly retaining a ball of a ball joint. Preferably, a ball joint retainer can be mounted over a socket of a housing. Also, a ball joint retainer may be removably coupled to an outer surface of a housing. Alternatively, a ball joint retainer may be removably coupled to an inner surface of a housing. A ball joint retainer preferably includes a flat plate with an inner surface and an outer surface, wherein the inner surface of the ball joint retainer can be disposed against the outer surface or inner surface of a housing. A ball joint retainer can, in certain cases, be coupled to an outer surface or outer surface of a housing via a structure selected from the group of bolts, screws, clamps, welding, and adhesive. A ball joint retainer may have an aperture through which a portion of a ball joint, e.g., ball or stem, may extend. Additionally, an inner surface of a ball joint retainer may in certain cases be abutted against a ball of a ball joint so as to inhibit egress of the ball joint from a socket of a housing, as exemplified in FIG. 4. Conversely, uncoupling of a ball joint retainer from a housing may, in some cases, remove obstruction against egress of the ball joint from a socket of the housing.

The term “chuck” as used herein is defined as a rotatable structure capable of removable coupling to an object, e.g., abrasive disc or stem of an abrasive assembly. A chuck may be rotatably coupled to a drive shaft of a motor. A chuck may extend through a central aperture of a pedestal. A chuck may have jaws, dogs, collets, pins, lugs, or dies that may be biased towards each other around a stem of an abrasive assembly to grip the stem.

The term “coupled” as used herein is defined as directly or indirectly connected, attached, or unitary, e.g., part of. A first object may be coupled to a second object such that the first object is positioned at a specific location and orientation with respect to the second object. A first object may be either permanently or removably coupled to a second object. Two objects may be permanently coupled to each other via adhesive or welding. Two objects may be removably coupled to each other via nails, screws, or nuts and bolts. Also, two objects may be capable of being threadably coupled together, where a threaded outer surface of one object e.g., a motor shell or a bolt, is capable of engaging with or to a threaded inner surface of another object e.g., a pedestal or a housing. Two threadably coupled objects may also be removably coupled. Two objects may be slidably coupled to each where the objects are adjacent to each other and one object may slide relative to the other object. For example, a pedestal may be slidably coupled to a housing.

The term “cylindrical” as used herein is defined as shaped like a cylinder, e.g., the shape of a structure having straight parallel sides and a circular or oval or elliptical cross-section. A cylindrical body or structure, e.g., housing, pedestal, chuck, stem, or abrasive assembly, may be completely or partially shaped like a cylinder. A cylindrical body or structure may have an end that is closed. A cylindrical body or structure, e.g., housing, may have an end that is open. A cylindrical body or structure, e.g., a chuck, may have opposing ends that are closed. A cylindrical body or structure, e.g., a pedestal or an abrasive assembly, may have opposing ends that are open. A housing, a pedestal, a chuck, a stem, or an abrasive assembly are examples of cylindrical bodies.

The term “exemplary” is used exclusively herein to mean “serving as an example, instance, or illustration.” Anything, including any version, structure, element, or step, described herein as exemplary, is not to be construed as preferred or advantageous over other version, structures, elements, steps, etc.

The term “housing” as used herein is defined as a structure having as a hollow structure, e.g., for receiving a pedestal. A housing may be removably coupled to a pedestal. A housing may be slidably coupled to a pedestal. A housing may be cylindrical.

The term “motor” as used herein is defined as a machine for providing motive power. A motor may include a body, a motor mounted within the body, and a chuck rotatably coupled to the motor. A motor may provide rotary motion, e.g., to a chuck and/or an abrasive assembly. Preferably, a motor is handheld. A motor may be electric and/or battery powered.

The term “pedestal” as used herein is defined as a structure configured for coupling a motor to a housing. A pedestal may be cylindrical. A pedestal may have a base and an upper portion extending from the base. A base and the upper portion may be unitary. A pedestal may have a borehole, e.g., aperture, extending through a base and an upper portion. A pedestal may have box threads capable of being threadably coupled to male threads on a shell of a motor. A pedestal may have a borehole, e.g., aperture, capable of receiving a drive shaft of a motor. A pedestal may have a borehole, e.g., aperture, capable of receiving a chuck. A pedestal may have an upper portion coupled to a housing.

The term “slot” as used herein is defined as an aperture configured for receiving a portion of a welding rod.

The term “socket” as used herein is defined as an aperture configured for receiving a portion, e.g., ball, of a ball joint. A socket may be disposed in a wall of a housing. A socket may be defined by a spherical or partially spherical surface disposed in a wall of a housing.

The term “spherical rotation” as used herein is defined as rotation in spherical coordinates. A spherically rotating object may have a center on which the object may rotate or turn in any direction. A protrusion extending from a spherical object capable of spherically rotation is said to be capable of circumduction if the protrusion can be moved in a circle while the center of the spherical object remains fixed. For example, a stem extending from a ball of a ball joint may be capable of circumduction because the stem can be moved in a circle while the center of the ball remains fixed.

The term “stem” as used herein is defined as a cylindrical structure, e.g., cylinder, tubular, cone, or frusto-cone. A stem may be solid. A stem may be hollow. A stem may have an aperture disposed therethrough. A guide stem may receive a welding rod.

The term “threaded” as used herein is defined as having threads. Threads may include one or more helical protrusions or grooves on a surface of a cylindrical object. Each full rotation of a protrusion or groove around a threaded surface of the object is referred to herein as a single “thread.” An object, e.g., motor, pedestal, housing, may include a “box thread” wherein a surface of the object defines an aperture in the object and the surface includes threads. An object, e.g., motor, pedestal, housing, stem, or knob, may include a “threaded portion” wherein a section of the object includes threads. A threaded portion of an object, e.g., motor, pedestal, housing, stem, or knob, may extend from an end of a non-threaded portion of the object. An object, e.g., motor, pedestal, housing, stem, or knob, may include more than one threaded portion. A threaded portion may, for example, refer to a portion of a cylindrical substructure of a first object, e.g., motor, knob, or bolt, having a threaded outer surface for mating with threads on second object, e.g., pedestal, housing, or nut. A threaded portion may have a diameter sized to extend through an aperture of a housing. In certain cases, a threaded portion of a first object, e.g., motor, knob, or bolt, may be removably coupled to the threaded portion of a second object, e.g., pedestal, housing, or nut.

The term “threaded assembly” as used herein refers to an assembly that includes threads, and preferably also includes one or more nuts, one or more bolts, one or more washers, and/or one or more spacers used for coupling two objects together. A nut, a washer, and a spacer may, for example, share a common central axis line. A nut may have a threaded inner surface that may mesh with outer threads on an object, e.g., threaded portion of a knob. A bolt may have a threaded outer surface that may mesh with inner threads on an object, e.g., a housing. A threaded assembly may comprise a washer that is disposed against and in physical contact with the outer surface of the ball joint retainer and a bolt having a threaded outer surface that is disposed against and in physical contact with the washer. When coupled to the threaded portion, the threaded assembly may be abutted against an outer surface of a ball joint retainer or a disc or cylinder of an abrasive assembly. A threaded assembly may further include one or more washers, and/or one or more spacers disposed against a ball joint retainer or housing. A threaded assembly may be disposed against an outer surface of a ball joint retainer. A threaded assembly may be coupled to a threaded portion of a wall of a housing.

The term “unitary” as used herein defined as having the nature, properties, or characteristics of a single unit. For example, a ball and a stem that are individual parts of a ball joint may be unitary in the sense they are not separate but rather are formed from a single piece of material, e.g. plastic, carbon fiber, metal, or wood. Also, a body and a wall of a housing that are individual parts may be unitary in the sense they are not separate but rather are formed from a single piece of material, e.g. plastic, carbon fiber, metal, or wood.

The term “wall” as used herein is defined as any structure having a planar surface. A wall may have curved planar sides that may or may not be parallel to one another. For example, a cylindrical wall may be a curved wall whose cross-section resembles a letter “0,” as exemplified by some of the pedestals, housings, ball joint retainer, or chucks disclosed herein.

The term “window” as used herein is defined as an aperture, e.g., for seeing into a housing.

The term “welding rod” as used herein is defined as a conductor for transferring electricity, e.g., for welding two objects together. A welding rod may be referred to as an electrode. A welding rod may include tungsten, steel, cast iron, stainless steel, copper, bronze, brass, and/or aluminum. A welding rod, e.g., pure tungsten welding rod, may have 99.50 percent tungsten. A welding rod, e.g., thoriated tungsten welding rod may have a minimum of 97.30 percent tungsten and 1.70 to 2.20 percent thorium. A welding rod, e.g., ceriated tungsten welding rod, may have a minimum of 97.30 percent tungsten and 1.80 to 2.20 percent cerium. A welding rod, e.g., lanthanated tungsten welding rod, may have a minimum of 97.80 percent tungsten and 1.30 percent to 1.70 percent lanthanum. A welding rod, e.g., zirconiated tungsten welding rod, may have a minimum of 99.10 percent tungsten and 0.15 to 0.40 percent zirconium. A welding rod, e.g., rare-earth tungsten welding rod, may have additives of rare-earth oxides or hybrid combinations of different oxides. A welding rod may be used in gas metal arc welding or gas tungsten arc welding.

### 3. Certain Specific Embodiments

Certain specific embodiments of methods, structures, elements, and parts are described below, which are by no means an exclusive description of the inventions. Other specific embodiments, including those referenced in the drawings, are encompassed by this application and any patent that issues therefrom.

The disclosure herein includes a grinding assembly for grinding a welding rod, which grinding assembly may include: a pedestal; a motor having a drive shaft extending through the pedestal; a chuck coupled to the drive shaft; a housing coupled to the pedestal; an abrasive disc coupled to the chuck and disposed within the housing; and a ball joint coupled to the housing and capable of spherical rotation, the ball joint comprising an aperture capable of receiving a portion of the welding rod.

The disclosure herein includes a grinding assembly for grinding a welding rod, which grinding assembly may include: a motor having a shell and a drive shaft; a chuck; a pedestal coupled to the shell, the pedestal having an aperture through which the chuck is extended; an abrasive assembly removably coupled to the chuck; a housing slidably coupled to the pedestal, the housing comprising: socket disposed therethrough; and a box thread extended through the housing and connected to the socket; a ball joint rotatably coupled to the socket of the housing, the ball joint comprising an aperture disposed therethrough; and a knob threadably extended through the box thread and releasably abutted against the ball joint.

The disclosure herein includes a grinding assembly for grinding a welding rod, which grinding assembly may include: a motor having a shell and a drive shaft; a chuck; a pedestal coupled to the shell, wherein the pedestal comprises: an aperture through which the chuck is extended; an abrasive assembly rotatably coupled to the chuck; a housing slidably coupled to the pedestal, the housing comprising: a base; a wall; a box thread extended through the base; and socket disposed in the wall; and a slot extended through the base and the wall; a ball joint disposed in the socket of the housing; and a knob threadably extended through the box thread of the housing and releasably abutted against the ball joint.

The disclosure herein includes a grinding assembly for grinding a welding rod, which grinding assembly may include: a motor having a shell and a drive shaft; a chuck; a pedestal coupled to the shell, the pedestal comprising: a central aperture through which the chuck extends; and a groove disposed in an outer surface of the pedestal; an abrasive assembly removably coupled to the chuck, a housing slidable coupled to the pedestal, the housing comprising: a base; a wall; a box thread extended through the base a socket disposed in the wall; a first box thread disposed through the base; a second box thread disposed through the wall and aligned with the groove of the pedestal; a slot extending through the base and the wall, wherein the slot is capable of receiving a portion of the welding rod; and a threaded assembly capable of being extended through the wall and into the second groove of the pedestal; a ball joint comprising: a ball disposed in the socket of the housing; a stem extending from to the ball; and an aperture extended through the ball and the stem and is capable of receiving a portion of the welding rod; a ball joint retainer coupled to the wall of the housing and abutted against the ball of the ball joint; a knob threadably extended through the first box thread disposed through the base of the housing; and a threaded assembly threadably extended through the second box thread and the groove of the of the pedestal.

The disclosure herein includes a grinding assembly for grinding a welding rod, which grinding assembly may include: a pedestal; a motor having a drive shaft extending through the pedestal; a chuck coupled to the drive shaft, the chuck comprising: a first cylinder having a face; and a second cylinder extending from the first cylinder; a housing coupled to the pedestal; and a grinding disc disposed in the housing, the abrasive disc comprising: an upper planar surface; a lower planar surface abutted against the face of the first cylinder; and an aperture receiving a portion of the second cylinder.

The disclosure herein includes a method of grinding a welding rod, which method may include: providing a grinding assembly, comprising: a pedestal; a motor coupled to the pedestal; a chuck rotatably coupled to the motor; a housing coupled to the pedestal; an abrasive disc coupled to the chuck and disposed in the housing; and a ball joint coupled to the housing and capable of spherical rotation; inserting an end of the welding rod through an aperture of the ball joint; spherically rotating the ball joint; abutting the end of the welding rod against the abrasive disc; rotating the abrasive disc with the motor; and grinding the end of the welding rod with the abrasive disc.

In any one of the structures or methods disclosed herein, the chuck may further include a threaded portion extended through an aperture of the abrasive assembly and coupled to a threaded assembly.

In any one of the structures or methods disclosed herein, the threaded assembly may be removably coupled to the chuck and in physical contact with the abrasive assembly.

In any one of the structures or methods disclosed herein, the threaded assembly may be coupled to a threaded portion of the chuck.

In any one of the grinding assemblies disclosed herein, the chuck, the central aperture of the pedestal, and the abrasive assembly may share a central axis.

In any one of the grinding assemblies disclosed herein, the wall of the housing may circumscribe the pedestal.

In any one of the grinding assemblies disclosed herein, the pedestal may further include a notch disposed in a corner of the pedestal and capable of receiving a portion of the welding rod.

In any one of the grinding assemblies disclosed herein, the housing may further include a slot extended therethrough and capable of being aligned with a first groove of the pedestal and receiving a portion of the welding rod.

In any one of the grinding assemblies disclosed herein, a portion of the ball of the ball joint may be extended through the ball joint retainer.

In any one of the grinding assemblies disclosed herein, a stem of the ball joint may be extended through the ball joint retainer.

In any one of the grinding assemblies disclosed herein, the ball joint may be capable of being swiveled relative to the housing.

In any one of the grinding assemblies disclosed herein, an aperture of the ball joint may be capable of receiving the welding rod.

In any one of the grinding assemblies disclosed herein, the knob may be releasably abutted against the ball joint.

In any one of the grinding assemblies disclosed herein, a stem of the ball joint may be extended through the ball joint retainer.

In any one of the grinding assemblies disclosed herein, a threaded may be assembly extended through the housing and into a groove of the pedestal.

In any one of the grinding assemblies disclosed herein, the abrasive assembly may have a plane capable of intersecting a plane of the slot extended through the housing.

In any one of the structures or methods disclosed herein, a portion of the ball joint may be disposed in a socket of the housing.

In any one of the structures or methods disclosed herein, the aperture of the ball joint may be open to the interior of the housing.

In any one of the structures or methods disclosed herein, the aperture of the ball joint extends in a direction of a surface of the abrasive disc.

In any one of the structures or methods disclosed herein, the ball joint may further include a stem capable of receiving a portion of the welding rod.

In any one of the structures or methods disclosed herein, the ball joint may further include a stem capable of circumduction relative to the housing.

In any one of the structures or methods disclosed herein, the housing may include a socket receiving a portion of the ball joint.

In any one of the structures or methods disclosed herein, the housing may include a slot disposed through an upper wall and a side wall of the housing.

In any one of the structures or methods disclosed herein, the housing may include a slot capable of receiving a portion of the welding rod.

In any one of the structures or methods disclosed herein, the housing may include: a slot capable of receiving a portion of the welding rod; and an aperture intersecting the slot, wherein the slot may be narrower than the aperture.

In any one of the structures or methods disclosed herein, the housing may include a window disposed above the abrasive disc.

In any one of the structures or methods disclosed herein, the pedestal may include an elongated groove receiving a pin extending through a wall of the housing, wherein the pin is capable of being slid along the groove.

In any one of the structures or methods disclosed herein, the motor may further include a shell removably coupled to the pedestal.

In any one of the structures or methods disclosed herein, a portion of the chuck may be disposed in an aperture of the pedestal.

In any one of the structures or methods disclosed herein, the chuck may include: a first cylinder having a face abutted against the abrasive disc; and a second cylinder extending from the first cylinder and received in an aperture of the abrasive disc.

Any one of the structures disclosed herein may further include a threaded assembly coupled to a threaded portion of the chuck and disposed against the upper planar surface of the abrasive disc.

Any one of the structures disclosed herein may further include a knob having a portion abutted against the ball joint.

Any one of the structures disclosed herein may further include a knob having a portion extending into the housing and abutted against the ball joint.

Any one of the structures disclosed herein may further include a knob having a portion threadably coupled to the housing and abutted against the ball joint.

Any one of the structures disclosed herein may further include a lock plate having an aperture receiving a portion of the ball joint.

Any one of the structures disclosed herein may further include a lock plate removably coupled to the housing and having a portion abutted against the ball joint.

Any one of the structures disclosed herein may further include a nut coupled to a threaded portion of the chuck and disposed against the upper surface of the abrasive disc.

Any one of the methods disclosed herein may further include inserting an end of the welding rod through an aperture disposed in the housing and a slot disposed in the housing, wherein the slot may intersect the aperture and the slot may be narrower than the aperture and the end of welding rod.

Any one of the methods disclosed herein may further include inserting a portion of the welding rod through a slot disposed in the housing.

Any one of the methods disclosed herein may further include grinding the portion of the welding rod with the abrasive disc.

Any one of the methods disclosed herein may further include positioning the welding rod at an angle relative to the abrasive disc.

Any one of the methods disclosed herein may further include pressing a lower surface of the abrasive disc against an upper surface of the chuck.

Any one of the methods disclosed herein may further include abutting a portion of a knob against a portion of the ball joint.

Any one of the methods disclosed herein may further include abutting a portion of a lock plate against a portion of the ball joint.

### 4. Specific Embodiments in the Drawings

The drawings presented herein are for illustrative purposes only and do not limit the scope of the disclosure. Rather, the drawings are intended to help enable one having ordinary skill in the art to make and use the assemblies disclosed herein.

This section addresses specific versions of grinding assemblies and methods for grinding welding rods. Although this section focuses on the drawings herein, and the specific versions found in those drawings, parts of this section may also have applicability to other versions not shown in the drawings. The limitations referenced in this section should not be used to limit the scope of the versions themselves, which have broader applicability.

Although the methods, structures, elements, and parts described herein have been described in detail, it should be understood that various changes, substitutions, and alterations can be made without departing from the spirit and scope of the versions disclosed herein. Those skilled in the art may be able to study the preferred versions and identify other ways to practice versions disclosed herein that are not exactly as described herein. It is the intent of the inventor that variations and equivalents of the disclosed versions are within the scope of the disclosure, while the description, abstract and drawings are not to be used to limit the scope of the disclosure. The disclosed versions are specifically intended to be as broad as described below and their equivalents.

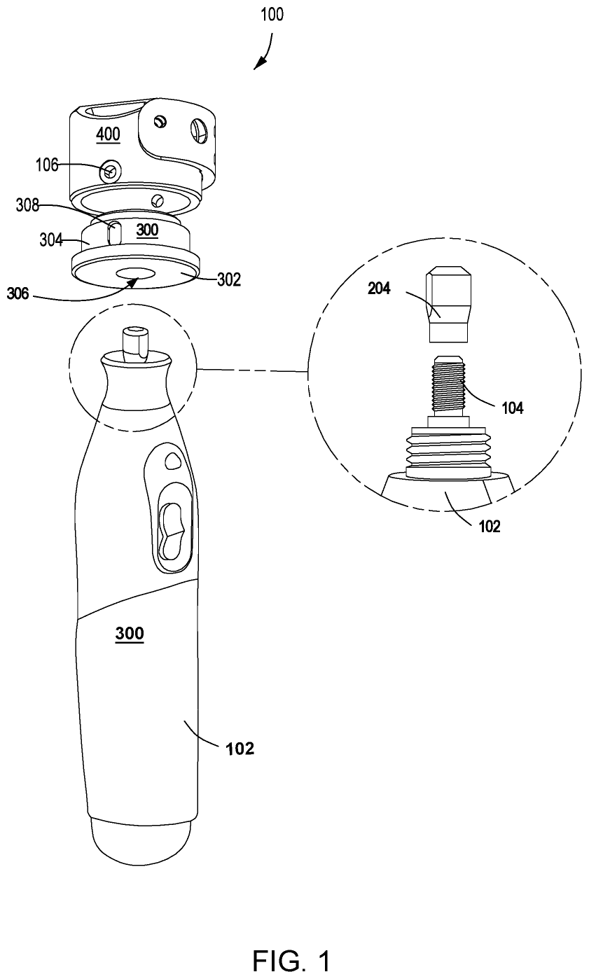

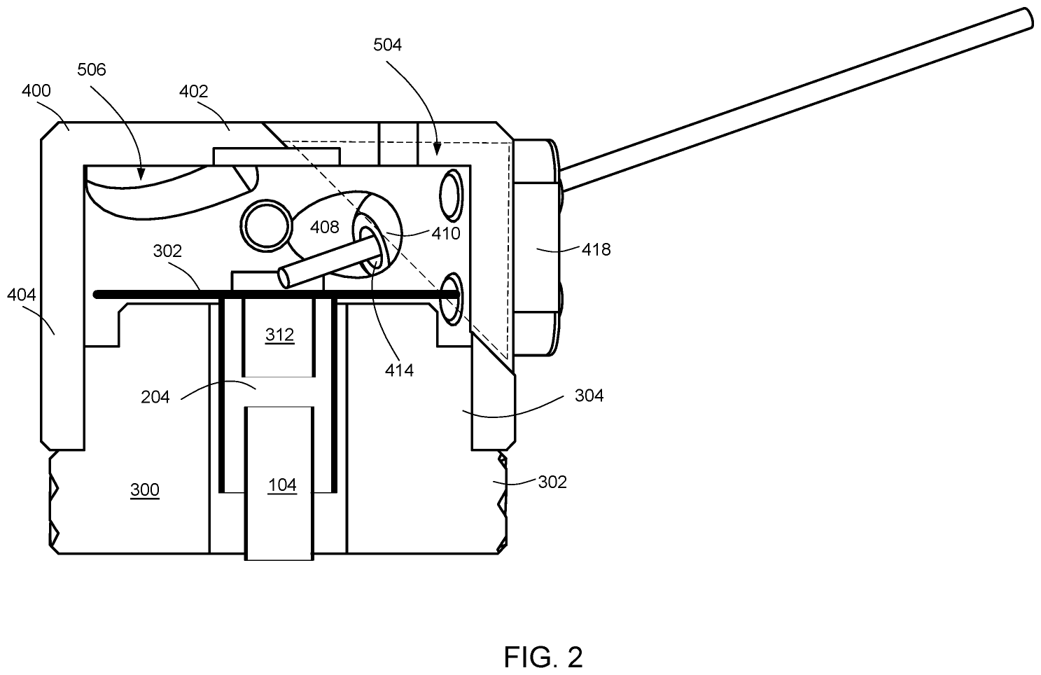

FIG. 1 illustrates an exploded view of a grinding assembly 100. FIG. 2 illustrates a cross-sectional side view of a pedestal 300 and a housing 400.

Referring to FIG. 1 and FIG. 2, the grinding assembly 100 may include a motor 200, a pedestal 300, and a housing 400. The motor 200 may include a shell 102, a drive unit (not shown), and drive shaft 104. The drive unit may be disposed in the shell 102. The drive unit may be coupled to the drive shaft 104. The drive shaft 104 may extend through the shell 102. When the drive unit is actuated, the drive shaft 104 would be rotated relative to the shell 102 or the pedestal 300.

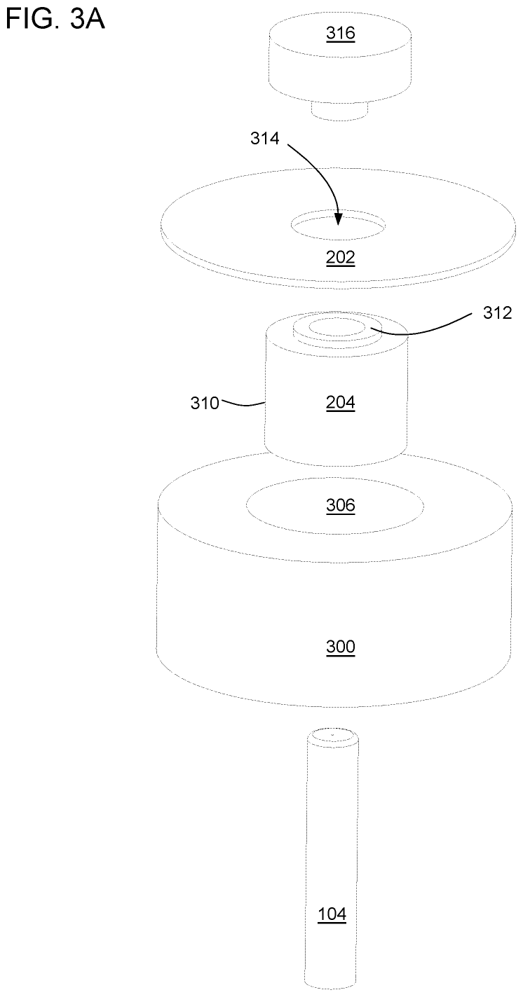

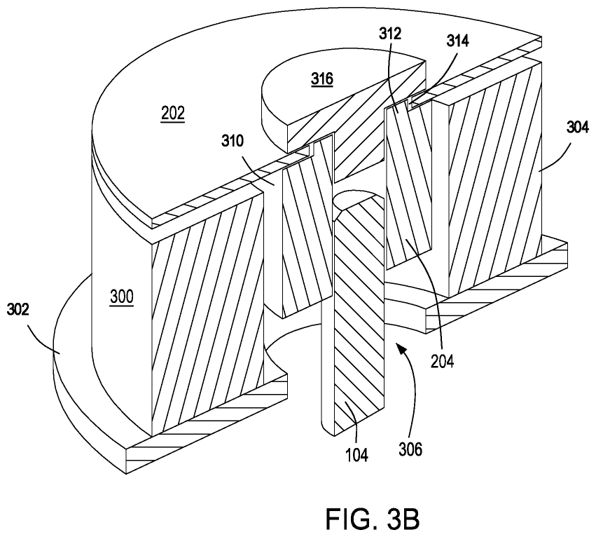

The pedestal 300 may be cylindrical. The pedestal may have a base 302 and an upper portion 304 extending from the base 302. The base 302 and the upper portion 304 may be unitary. Moreover, the pedestal 300 may have a borehole 306, e.g., aperture, extending longitudinally through the base 302 and the upper portion 304. An inner surface defining the borehole 302 may have box threads (not shown). The box threads may be capable of being threadably coupled to male threads disposed on the shell 102 of the motor 200. The drive shaft 104 of the motor 200 is capable of extending through the borehole 306 (see FIG. 3B).

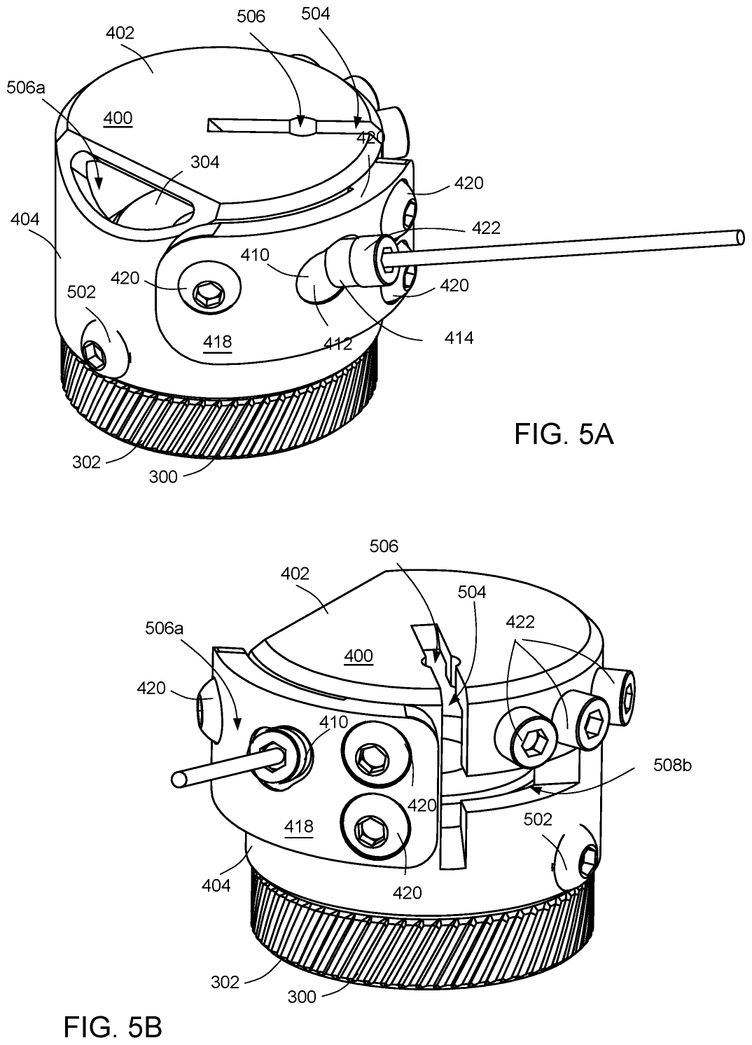

Still referring to FIG. 1 and FIG. 2, the upper portion 304 of the pedestal 300 may be sized to fit within an opening 406 of the housing 400. Thus, the upper portion 304 may be slid into the opening 406. The housing 400 may have an aperture 106 extending therethrough. A surface of the housing 400 defining the aperture 106 may have box threads (not shown). A bolt 502 (see FIG. 5A) may extend through the aperture 106. Additionally, the bolt 502 may be threadably coupled to the box threads. Furthermore, the bolt 502 may extend through the housing 400 into an elongated groove 308 of the upper portion 304 of the pedestal 300. The elongated groove 308 may be disposed on an outer surface of the upper portion 304.

A welder may extend the bolt 502 farther through the wall 404 and the elongated groove 308 by turning the bolt 502 in a clockwise direction. Alternatively, the welder may retract the bolt 502 from the wall 404 and the elongated groove 308 by turning the bolt 502 in a counterclockwise direction. The bolt 502 may be slid along the elongated groove 308.

Referring to FIG. 2 and FIGS. 3A-B, an abrasive disc 202 may be disposed within the opening 406 of the housing 400. The abrasive disc 202 may be disposed between the pedestal 300 and the housing 400. In some cases, the abrasive disc 202 may not physically touch the pedestal 300. In some cases, the abrasive disc 202 may not physically touch the housing 400.

The abrasive disc 202 may be coupled to a chuck 204. The chuck 204 may have a first cylinder 310 and the second cylinder 312. The first cylinder 310 and the second cylinder 312 may be unitary. The second cylinder 312 may have a diameter smaller than that of the first cylinder 310. The second cylinder 312 may be received in an aperture 314 of the abrasive disc 202. Thus, when coupled to the chuck 204, the abrasive disc 202 would have a lower planar surface abutted against an upper face of the first cylinder 310. An inner surface of the abrasive disc 202 defining the aperture 314 may be abutted against an outer of the second cylinder 312.

A threaded assembly 316, e.g., bolt, having a male threaded portion may extend through abrasive disc 202. The male threaded portion may be threadably coupled to box threads disposed on an inner surface of the chuck 204. A head of the threaded assembly 316 may be abutted against an upper planar surface of the abrasive disc 202. Thus, the threaded assembly 316 may retain the abrasive disc 202 against the chuck 204. Additionally, in some cases, when pressure is applied to the abrasive disc 202, the chuck 204 and the threaded assembly 316 would minimize or prevent the abrasive disc 202 (which is rigid) from being moved, e.g., rotated, bent, or shifted, relative to the chuck 204 and the threaded assembly 316.

In addition, the chuck 204 may be coupled to a drive shaft 104. The chuck 204 may have box threads (not shown) threadably coupled to male threads of the drive shaft 104 (not shown). The drive shaft 104 and the chuck 204 may be received in a borehole 306 of the pedestal 300.

The drive shaft 104 may be part of a motor of a motor 200 (see FIG. 1). The motor 200 may be coupled to the pedestal 300. The drive shaft 104 may be rotatably coupled to a drive unit (not shown) of the motor 200. Thus, when the drive shaft 104 is rotated by the drive unit, the drive shaft 104, the chuck 204, and abrasive disc 202 would be rotated relative to the pedestal 300.

FIG. 4 illustrates an exploded view of a pedestal 300 and a housing 400. The house 400 may have a circular base 402 and wall 404 extending from the base 402. Preferably, the base 402 and the wall 404 are unitary. The base 402 and the wall 404 may be coupled to form a ninety (90) degree angle. Accordingly, the housing 400 may be a hollow cylinder. Moreover, the housing may have an opening 406 at one end (see FIG. 1).

Referring to FIG. 4 and FIGS. 5A-B, a socket 408 may be disposed through the wall 404. A portion of a ball joint 410 may be disposed in the socket 408. The ball joint 410 may include a ball 412. The ball joint 410 may also include a stem 414. Preferably, the ball 412 and the stem 414 are unitary. Also, an aperture 416 may be extended through the ball 412 and the stem 414. The aperture 416 may receive a welding rod during operation of the grinding assembly 100.

A portion of the ball 410 may be disposed in the socket 408. Additionally, the stem 414 may extend through an aperture 419 dispose through a ball joint retainer 418. The ball joint retainer 418 may be coupled to the wall 404 of the housing 400. Bolts 420 may extend through the ball joint retainer 418. The bolts 420 may retain the ball joint retainer 418 abutted against the wall 404. When coupled to the wall 404, the ball joint retainer 418 would retain the ball 412 between wall 404 and the ball joint retainer 418.

To inhibit movement, e.g., spherical rotation, of the ball 412, a welder may turn the bolts 420 in a first direction, e.g., clockwise, to cause the bolts 420 to be abutted against the ball joint retainer 418 against ball 412. Abutting the ball joint retainer 418 against ball 412 may also cause the ball 412 to be abutted against the wall 404. Therefore, in some cases, when the ball 412 is abutted against both the wall 404 and the ball joint retainer 418, friction would inhibit the ball 412 from rotating relative to the housing 400 and/or the ball joint retainer 418.

To permit movement, e.g., spherical rotation, of the ball 412, a welder may turn the bolts 420 in a second direction, e.g., counterclockwise, to cause ends of the bolts 420 to move away from the ball joint retainer 418. Accordingly, the ball joint retainer 418 may be moved away from the housing 400 and the ball 412. Therefore, the ball 412, in some cases, may no longer be abutted against the wall 404 and/or the ball joint retainer 412. Accordingly, the ball 412 may be spherically rotated within socket 408, relative to the housing 400 and/or ball joint retainer 418.

In other words, the ball 412 would then be capable of spherically rotated while still being disposed between the wall 404 and ball joint retainer 418.

In addition, a rod guide 422 may be coupled to the stem 412 of the ball joint 410. The rod guide 422 have an aperture dispose therethrough. The aperture of the rod guide 422 may be smaller than aperture 416 extending through the ball joint 410. The aperture of the rod guide 422 may be of different sizes to fit welding rods having different diameters. A surface forming the aperture of the rod guide 422 may have a diameter ranging from as small as 1 mm, 1.5 mm, 2 mm, 2.4 mm, 2.5 mm, to as large as 3.15 mm, 3.2 mm, 4.0 mm, or 4.8 mm, or larger.

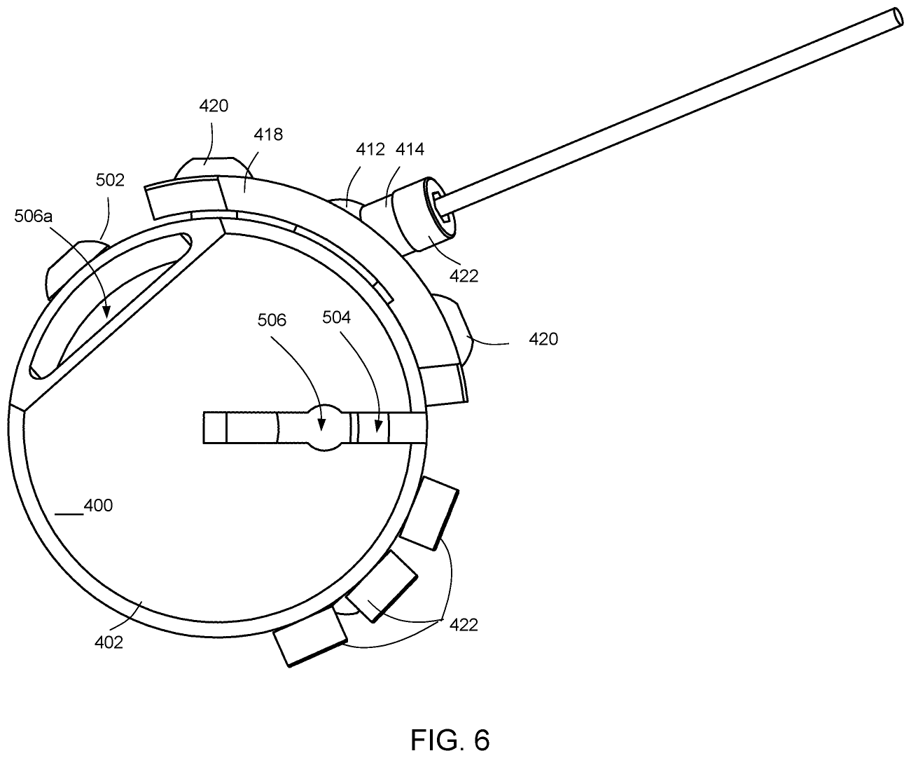

Referring to FIGS. 3 and 4-6, a slot 504, an aperture 506, and windows 508a, 508b may be disposed in the housing 404. The windows 508a, 508b may each extend through a wall 404 of the housing 400. Each window 506 may be disposed above an abrasive disc 202. Each window 506 may be disposed above the abrasive disc 202 so that a welder may see the grinding of a welding rod. For example, the window 508a may extend thorough the base 402 and the sidewall 404, as shown in FIG. 5A.

The slot 504 may extend through the base 402 and the wall 404 of the housing 400. The slot 504 may extend through a corner of the base 402 and the wall 404. The slot 504 may be a triangular opening 702, shown as dash lines in FIG. 2. An abrasive disc 202 disposed perpendicular to the wall 404 may intersect the slot 504. Thus, if a welding rod were positioned within the slot 504, in some cases, a portion the welding rod would be abutted against an outer edge of the abrasive disc 202.

The aperture 506 may extend through the base 402 of the housing 400. Moreover, the aperture 506 may intersect the slot 504 disposed in the housing 400. Both the slot 504 and the aperture 506 may be defined by one continuous surface. However, a first portion of the continuous surface defining the aperture 506 may have a diameter longer than the width of a second portion of the continuous surface defining the slot 504. The second portion of the continues surface defining the slot 504 may have a width ranging from as small as 1 mm, 1.5 mm, 2 mm, 2.4 mm, 2.5 mm, to as large as 3.15 mm, 3.2 mm, 4.0 mm, or 4.8 mm, or larger.

Referring to FIGS. 1-7, to sharpen a welding rod, a welder may slide a welding rod through an aperture 416 of the ball joint 410 until an end of the welding rod may be abutted against an upper surface of the abrasive disc 202. Additionally, the welder may slide the welding rod through rod guide 422 coupled to the ball joint 410. The rod guide 422 and the ball joint 410 may have apertures that are aligned.

The welder may adjust the angle of sharpness of the welding rod by swiveling the ball joint 410 to a desired angle relative to an upper face of the abrasive disc 202. Then, the welder may turn the bolt 420 until a portion of a ball joint retainer 418 is abutted against a ball 410 of the ball joint 410, thereby inhibiting movement, e.g., spherical rotation, pivoting, and/or swiveling, of the ball joint 410. Next, the welder may actuate a motor 200 to rotate the abrasive disc 202 and grind against the welding rod. As the end of the welding rod is being ground against the abrasive disc 202, the welder may rotate the welding rod until it has a sharp point.

Additionally, a welder may cut a welding rod before sharpening the welding rod. First, the welder may insert a welding rod lengthwise through the slot 504. The welder may then actuate the motor to the rotate the abrasive disc 202. Next, the welder may press a portion of the welding rod against the abrasive disc 202. Since the abrasive disc 202 is rotating, it will shear the welding rod. The welder may continue to press the welding rod against the abrasive disc 202 unit it is completely cut.

In some cases, a used welding rod may have an end that has accumulated material during use. The accumulated material may cause the end of the rod to be of a size that, in some cases, cannot be slid through the aperture 416 of the ball joint 410 or the slot 504. Instead, the welder may extend the end of the welding rod through and aperture 506 disposed in the housing 400. Next, the welder may pivot and/or slide the welding rod along the slot 504 until the end of welding rod is abutted against the abrasive disc 202. Afterward, the welder may grind the end of the welding rod until the accumulated material is removed from the welding rod.

What is claimed as the invention is:

1. A grinding assembly for grinding a welding rod, comprising:
a pedestal;
a motor having a drive shaft extending through the pedestal;
a chuck coupled to the drive shaft;
a housing coupled to the pedestal;
an abrasive disc coupled to the chuck and disposed within the housing; and
a ball joint coupled to the housing and capable of spherical rotation, the ball joint comprising an aperture capable of receiving a portion of the welding rod.

2. The grinding assembly of claim 1, wherein a portion of the ball joint is rotatably coupled to the housing.

3. The grinding assembly of claim 1, wherein the aperture of the ball joint is open to the interior of the housing.

4. The grinding assembly of claim 1, wherein the aperture of the ball joint extends in a direction of a surface of the abrasive disc.

5. The grinding assembly of claim 1, wherein the ball joint further comprises a stem capable of receiving a portion of the welding rod.

6. The grinding assembly of claim 1, wherein the ball joint further comprises a stem capable of circumduction relative to the housing.

7. The grinding assembly of claim 1, wherein the housing comprises a socket receiving a portion of the ball joint.

8. The grinding assembly of claim 1, wherein the housing comprises a slot capable of receiving a portion of the welding rod.

9. The grinding assembly of claim 1, wherein the housing comprises:
a slot capable of receiving a portion of the welding rod; and
an aperture intersecting the slot, wherein the slot is narrower than the aperture.

10. The grinding assembly of claim 1, wherein the housing comprises a window disposed above the abrasive disc.

11. The grinding assembly of claim 1, wherein the pedestal comprises an elongated groove receiving a pin extending through a wall of the housing, wherein the pin is capable of being slid along the groove.

12. The grinding assembly of claim 1, further comprising a lock plate removably coupled to the housing and having a portion abutted against the ball joint.

13. [symbol] claim 1, wherein the chuck comprises:
a first cylinder having a face abutted against the grinding disc; and
a second cylinder extending from the first cylinder and received in an aperture of the abrasive disc.

14. A grinding assembly for grinding a welding rod, comprising:
a pedestal;
a motor having a drive shaft extending through the pedestal;
a chuck coupled to the drive shaft, the chuck comprising:
a first cylinder having a face; and
a second cylinder extending from the first cylinder;
a housing coupled to the pedestal; and
an abrasive disc disposed in the housing, the abrasive disc comprising:
an upper planar surface;
a lower planar surface abutted against the face of the first cylinder; and
an aperture receiving a portion of the second cylinder.

15. [symbol] claim 14, further comprising a threaded assembly coupled to a threaded portion of the chuck and disposed against the upper planar surface of the abrasive disc.

16. A method of grinding a welding rod, comprising:
providing a grinding assembly, comprising:
a pedestal;
a motor coupled to the pedestal;
a chuck rotatably coupled to the motor;
a housing coupled to the pedestal;
an abrasive disc coupled to the chuck and disposed in the housing; and
a ball joint coupled to the housing and capable of spherical rotation;
inserting an end of the welding rod through an aperture of the ball joint;
spherically rotating the ball joint;
rotating the abrasive disc with the motor;
abutting the end of the welding rod against the abrasive disc; and
grinding the end of the welding rod with the abrasive disc.

17. The method of claim 16, further comprising inserting a portion of the welding rod through a slot disposed in the housing.

18. The method of claim 16, further comprising inserting an end of the welding rod through an aperture disposed in the housing and a slot disposed in the housing, wherein the slot intersects the aperture and the slot is narrower than the aperture and the end of welding rod.

19. The method of claim 16, further comprising positioning the welding rod at an angle relative to the abrasive disc.

20. The method of claim 16, further comprising pressing a lower surface of the abrasive disc against an upper surface of the chuck.
